(19) United States
(12) Patent Application Publication
(10) Pub. No.: US 2006/0207032 A1
(43) Pub. Date: Sep. 21, 2006

(54) Process for hydrophobing leather by means of alkylalkoxysilanes, and water-repellent leather

(75) Inventors: Juergen Reiners, Leverkusen (DE); Martin Kleban, Leverkusen (DE); Matthias Bley, Solingen (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/368,053

(22) Filed: Mar. 3, 2006

(30) Foreign Application Priority Data
Mar. 17, 2005 (DE) 10 2005 012 329.5

(51) Int. Cl. C14C 3/08

(52) U.S. Cl. 8/94.33

(57) ABSTRACT

Process for hydrophobing a leather tanned with organic tanning agents, characterized in that the leather is treated with a preparation containing at least one alkylalkoxysilane of the formula I
R¹R² Si(OR³)(OR⁴) (I), in which
R¹ represents a C₁-C₃₀-hydrocarbon radical, in particular an aliphatic, preferably an aliphatic, saturated C₆-C₂₀-radical, particularly preferably hexadecyl or octadecyl,
R³ and R⁴, independently of one another, represent a C₁-C₁₀-hydrocarbon radical, in particular an aliphatic C₁-C₁₀-radical, preferably saturated, particularly preferably a C₁-C₄-radical, methyl, ethyl, propyl or isopropyl being preferred, and
R², independently of R¹, has the meaning of R¹ or represents OR³ or OR⁴.

The invention relates to a process for hydrophobing leather, in particular sole leather, by means of alkylalkoxysilanes, and to water-repellent leather.

For the production of leather from hides and skins, tanning with trivalent chromium salts is now the predominant technology worldwide. The process is economical, simple and easy to reproduce. The leathers obtained are distinguished by high quality and a large achievable property range.

Only a few leather articles are produced today without the use of chromium salts, owing to technical requirements. Sole leather and other leather articles, such as belts, bridles, straps or bags, in which the required leather has to be extremely compact, strong and durable, are particularly singled out here.

In this context, tanning with large amounts of vegetable or synthetic tanning agents has survived to date and can be carried out in its traditional form in pits (“oak bark ground tanning”), in the modern variant also with a combination of pit and drum (“rocker yard—drum tanning”) or exclusively in tanning drums (“C-RFP process”; Rationelle pflanzliche Gerbungen [Efficient vegetable tanning], E. Lau, Leather, 1989, 51).

A property increasingly demanded by the market for many leather articles is improved resistance to the action of water. Low water absorption and a long time for penetration of water under test conditions similar to the conditions of use are demanded here. In the upper leather area which is most important in this context, and with the use of chromium salts for tanning and fixing, various hydrophobing systems have been launched on the market and are protected in some cases (e.g. DE 10306748 or WO 03/064707). They are generally based on combinations of suitable paraffins, polymers and/or silicones and occasionally fluorine compounds, which are used in retanning. For this purpose, they are introduced with an emulsifier into the aqueous liquor and fixed by destroying the emulsifier by means of mineral salts, in particular chromium. As a result of the fixing, the hydrophobic substances are anchored in the leather matrix to such an extent that they cannot migrate during the subsequent use of the leather article and, for example, cause colour changes, grease spots or adhesion problems during adhesive bonding. Typical amounts used are 8-15% of product mix per hydrophobing agent, based on shaved weight. An overview of the prior art is to be found, for example, in Modern hydrophobic systems: new water repellents and retannages for shoe uppers, P. Danisch et al., JALCA, 1996, 120-125. Where necessary for ecological reasons, the fixing of the hydrophobing treatment on chrome-tanned leather can be achieved today even without mineral salts (Waterproofing of leather—state of the art and new concepts, M. Kleban et. al., JALCA, 2002, 487-495; WO 2001055456: Cyanourea group-containing polysiloxanes used for waterproofing leather).

DE-A 10250111 furthermore describes a process for the production of water-repellent, chromium-free leather based on a substrate tanned using iron salts.

Moreover, WO 96/15276 describes a leather which is produced using polymeric tanning agents and can be provided with a water-repellent treatment to a certain extent according to DE 19629986. As emphasized in the description and the examples, such leathers are exclusively very thin, particularly soft leathers which are designed in particular for use as upholstery leather. Moreover, neither vegetable nor synthetic tanning agents may be used in this process, which greatly limits the achievable possible leather properties.

A common property of the active substances of all known hydrophobing systems is that they make leather not only water-repellent but also soft and flexible. They therefore cannot be used in the required amount if the technical requirements which the leather article has to meet require very high strength and durability, such as, for example, for shoe soles.

Moreover, the use of hydrophobing agents in the aqueous liquor in the production of sole leather is disadvantageous in the pit tanning process since there the liquor with unconsumed active substances and auxiliaries is not discharged, so that these collect in the pit and may cause undesired side effects in subsequent tanning processes.

Products for the water-repellent treatment of the surface of leather, such as, for example, polymeric organofluorine compounds (e.g. “Scotchgard®”, manufacturer 3M, e.g. World Leather, 2003, 33-35; “Leather Protector®”, manufacturer Dupont, z. B. Leather International, 2002/2003, 41-44; “Baygard®”, manufacturer LANXESS), are also not suitable for the production of sole leather since the protective layer on the surface is destroyed by mechanical load even on brief use. In order to obtain a long-term treatment, the hydrophobing agent must therefore penetrate the leather as uniformly and completely as possible.

The systems existing on the market for the production of water-impermeable leather soles are therefore based on complicated, expensive “mechanical” processes in which, for example, a conventional leather sole is horizontally split and a water-impermeable textile membrane (e.g. “Goretex®”) is stuck in and sewn.

The object of the invention is therefore an agent for the hydrophobic treatment of leather subjected to vegetable and/or synthetic tanning, which agent completely penetrates the leather cross section, can be effectively fixed in the leather, does not make the leather soft and ideally can be used not in the tanning but on the completely tanned and dried leathers.

It has now been found that a leather tanned with organic tanning agents which is characterized in that it is treated with at least one alkylalkoxysilane of the formula I
R¹R² Si(OR³)(OR⁴) (I),
in which
R¹ represents a C₁-C₃₀-hydrocarbon radical, in particular an aliphatic, preferably an aliphatic, saturated C₆-C20-radical, particularly preferably hexadecyl or octadecyl,
R³ and R⁴, independently of one another, represent a C₁-C₁₀-hydrocarbon radical, in particular an aliphatic C₁-C₁₀-radical, preferably saturated, particularly preferably a C₁-C₄-radical, methyl, ethyl, propyl or isopropyl being preferred, and
R², independently of R¹, has the meaning of R¹ or represents OR³ or OR⁴,
   achieves this object.

The leathers subjected to organic tanning, in particular vegetable and/or synthetic tanning, are preferably characterized in that at least 20 percent by weight, particularly preferably 30 percent by weight, of organic tanning agents, in particular vegetable tanning agents, and/or synthetic tanning agents, such as, for example, condensates of aromatic sulphonic acids or resin tanning agents, are used for their production, and moreover, in a particularly preferred form, no mineral tanning agents, in particular chromium salts, are used. An overview of the chemistry and the definition of these tanning agent classes is to be found, for example, in Theorie und Praxis der organischen Gerbstoffe [Theory and practice of organic tanning agents], G. Reich, Das Leder, 1996, 74-83 and 157-171. The intended use of these leathers is primarily for the production of shoe soles, but also leather articles, such as bags, straps, belts, bridles, saddles and the like.

The synthetic tanning agents suitable for this use are, for example, water-soluble condensates of sulphonated aromatics, formaldehyde and optionally further substances, for example aromatics, urea and/or urea derivatives. Products based on the condensation of naphthalenesulphonic acids, ditolylethersulphonic acids, phenolsulphonic acids, dihydroxydiphenyl sulphones and phenol and combinations of these raw materials with formaldehyde and optionally urea or urea derivatives are preferred here.

The so-called resin tanning agents are understood as meaning condensates of nitrogen-containing compounds, such as, for example, urea, dicyandiamide or melamine, with formaldehyde and/or other aldehydes and optionally sulphites.

Vegetable tanning agents are tanning agents obtained from plant sources and belong to the classes consisting of the condensed tanning agents or hydrolysable tanning agents, e.g. chestnut extract, mimosa, tara or quebracho.

The leather to be rendered hydrophobic is preferably “chromium-free”, “chromium-free” meaning, in the context of the present invention, that it was not tanned using chromium salts. The maximum proportion of chromium, due to natural sources of Cr in animal hides or chromium-containing dyes, in leather is less than 2000 ppm. For leathers not dyed with chromium dyes, the maximum proportion of chromium in the leather is preferably less than 100 ppm.

Particularly preferred alkoxysilanes of the formula I are dialkyldimethoxysilane, alkyltrimethoxysilane, dialkyldiethoxysilane, alkyltriethoxysilane or mixtures thereof, alkyl representing C₆-C₂₀-alkyl; hexadecyltrimethoxysilane, octadecyltrimethoxysilane, hexadecyltriethoxysilane, octadecyltriethoxysilane or mixtures thereof are very particularly preferred.

In their pure form, the alkylalkoxysilanes of the formula I which are used are colourless or yellowish, low-viscosity liquids having viscosities in the range of 0.6-10 000 mpa·s, preferably 0.8-1000 mpa·s, and a boiling point of >100° C., particularly preferably >180° C.

They are known, for example, as intermediates for the preparation of, for example, polysiloxanes or other silicon-containing polymers. In addition, alkylalkoxysilanes are frequently used for the hydrophobic modification of substrate materials. Thus, for example, DE-A-10320779 describes corrosion inhibition for metals, or U.S. Pat. No. 4,874,431 describes low-volatility hydrophobing agents for cement and building materials.

In the presence of water, alkylalkoxysilanes hydrolyse to give alkylsilanol, which can polymerize with elimination of water or can bind to nucleophilic reagents. This reaction can be catalysed, for example, by acids.

It has been found that the alkylalkoxysilanes of the formula I particularly are suitable for use as hydrophobing agents for leathers subjected to organic tanning, in particular vegetable or synthetic tanning, and give, as a product of the hydrolysis and secondary reaction, a waxy substrate, preferably having a melting point above 25° C., particularly preferably above 50° C.

The invention furthermore relates to a process for the production of the leather according to the invention, which is characterized in that leather subjected to organic tanning is treated with a preparation containing at least one alkylalkoxysilane of the formula I, in particular the preparation is applied to the surface.

For carrying out the hydrophobing, altogether 2-30% by weight, preferably 5 - 15% by weight are preferably applied to the completely tanned and dried (i.e. residual moisture content of <30% by weight, preferably <20% by weight) leather on one or both sides. The application of the mixture of substances is preferably effected at 0° C.-60° C. The application can be effected, for example, by spraying on, applying with a knife coater, pouring, printing or immersion.

In order to optimize the penetration behaviour and the viscosity of the preparation on the leather article and the method of application, various solvents and/or oils may be added to the alkylalkoxysilanes used. For example, alcohols, such as methanol, ethanol, propanol or isopropanol, and solvents not reactive with alkylalkoxysilanes, such as aliphatic or aromatic hydrocarbons, halogenated hydrocarbons, ethers, esters or low molecular weight silicone oils, in particular benzines, white oils, polysiloxanes and ethyl acetate and mixtures of these components are suitable for reducing the viscosity. For example, highly viscous mineral oils, fats, waxes or relatively high molecular weight silicone oils, in particular polysiloxanes, with and without functionalization by, for example, hydroxyl, amino or carboxyl functionalities, and mixtures of these components are suitable for increasing the viscosity.

For the hydrophobing, it is preferable to use a preparation containing at least 30% by weight, preferably at least 50% by weight, in particular at least 80% by weight, especially at least 95% by weight, of alkylalkoxysilanes of the formula I.

After the application of the hydrophobing agent, the leather is, if required, dried in the air if readily volatile constituents are contained in the product mixture, and the hydrophobing agent is fixed, for example, by storing the leathers. The residual moisture contained in the leather and the acid introduced with the tanning agent is sufficient here as a medium for the hydrolysis reaction of the alkoxy functions on the silane, which subsequently leads to crosslinking of the silicon units with one another or with nucleophilic functionalities in the leather. The reaction rate is dependent on the alkoxy radical present. In a further embodiment, this reaction can be accelerated by providing vapour by contact with or conditioning in a humid and/or acidic atmosphere. Suitable acids are, for example, readily volatile organic acids, such as formic acid or acetic acid, but also readily volatile inorganic acids, such as, for example, hydrochloric acid.

The leathers according to the invention preferably have a drop fastness of at least 30 minutes and a water absorption in the Kubelka test (DIN EN 12 990) of less than 35% in 24 hours. For determining the drop fastness, a water drop of 0.2 ml volume is applied to the leather surface (grain side) and the time taken for the drop to be completely drawn into the leather is measured. Longer times correspond to better water repellency.

The leather according to the invention is outstandingly suitable for use for shoe production, in particular as shoe sole leather and as belt, saddle, strap and bag leather.

The invention furthermore relates to the leathers obtainable by the process according to the invention.

The invention also relates to the use of alkylalkoxysilanes of the formula I for hydrophobing leather tanned using organic tanning agents.

The examples described below are intended to further illustrate the invention but not to limit it. All weight data in the tannings relate to pelt weight, and weight data in the hydrophobing relate to the weight of the tanned and dried leather.

Leather 1 Production of Sole Leather in the C-RFP Process

Raw material: Delimed and bated butts (German bulls, fleshed)

| | % | Product | ° C. | Time | |
|---|---|---|---|---|---|
| Washing | 100 | Water | 20 | 10′ | Discharge |
| Conditioning | 4.5 | Synthetic conditioning product* | | 15′ | 3 rpm |
| | 2.5 | Formic acid | | 3′ | 3 rpm pH = 3.6 |
| Pretanning | 8 | Synthetic pretanning agent** | | 2 h | 3 rpm |
| | | | | 2 h | 1 rpm |
| | | Intermittent operation 5′ × 60′ | | 8 h | pH = 3.6 |
| | | | | | Discharge |
| Washing | 50 | Water | 20° | | |
| | 0.5 | Synthetic pretanning agent** | | 20′ | 3 rpm |
| | | | | | Discharge |
| 1st tanning cycle | | | | | |
| | 8 | Synthetic tanning agent*** | | | |
| | 4 | Sweetened chestnut vegetable | | | |
| | | tanning agent | | | |
| | 1 | Fatliquoring agent | | 2 h | |
| 2nd tanning cycle | | | | | |
| | 4 | Synthetic tanning agent**** | | | |
| | 6 | Sweetened chestnut vegetable | | | |
| | | tanning agent | | | |
| | 4 | Synthetic tanning agent***** | | | |
| | 0.3 | Fatliquoring agent | | 2 h | |
| | 4 | Vegetable tanning agent | | | |
| | | Mirobolan | | | |
| | 4 | Synthetic tanning agent**** | | | |
| | 4 | Synthetic tanning agent***** | | | |
| 3rd tanning cycle | 4 | Sweetened chestnut vegetable | | | |
| | | tanning agent | | | |
| | 0.2 | Neatsfoot oil | | 2 h | |
| | 10 | Water | 20° | 10 h | |
| | 30 | Water | 35° | | |
| | 0.5 | Synthetic bleach tanning | | 30′ | Discharge |
| | | agent****** | | | |

On standing for 5 days, samming, shaving, drying, rolling
*Strongly acidic naphthalenesulphonic acid/formaldehyde condensate BAYSEL ® C, LANXESS Deutschland GmbH
**Napthalenesulphonic acid/formaldehyde condensate, TANIGAN ® RFS, LANXESS Deutschland GmbH
***Phenol/phenolsulphonic acid/formaldehyde condensate, TANIGAN ® LT, LANXESS Deutschland GmbH
****Naphthalenesulphonic acid/dihydroxydiphenyl sulphone/formaldehyde condensate, TANIGAN ® F, LANXESS Deutschland GmbH
*****Ditolylethersulphonic acid/dihydroxydiphenyl sulphone/formaldehyde condensate, TANIGAN ® WLF, LANXESS Deutschland
******Naphthalenesulphonic acid/formaldehyde condensate-containing bleach, TANIGAN ® BL, LANXESS Deutschland GmbH

Leather 2 Production of a Bag Leather

Delimed and bated cattle pelts (German cattle, split thickness 4 mm) are bated in 80% of water for 2 h with 8% of sodium chloride, 0.7% of formic acid and 0.9% of sulphuric acid in a commercial tanning drum and then pretreated for 12 h with 6% of a synthetic pretanning agent (ditolylethersulphonic acid/dihydroxydiphenyl sulphone/formaldehyde condensate, TANIGAN®CK, LANXESS Deutschland GmbH). The liquor is discharged, washing is effected twice and the liquor is made up again with 30% of water. 3% of a synthetic tanning agent (naphthalenesulphonic acid/dihydroxydiphenyl sulphone/formaldehyde condensate, TANIGAN®OS, LANXESS Deutschland GmbH), 8% of mimosa tanning agent, 5% of chestnut tanning agent and 1% of a neatsfoot oil-based fatliquoring agent and, after one hour, a further 3% of synthetic tanning agent, 8% of mimosa tanning agent, 5% of chestnut tanning agent and 2% of a polymeric resin tanning agent (polyacrylic acid, Leukotan®1028, Rohm and Haas Corp.) are added. After continuous operation for 8 h and intermittent operation for 12 h (5 min/h), the resulting pH is 3.8, and the liquor is discharged and the leather washed and then sammed. The moist leather is then treated, without liquor, for two hours with 1.5% of synthetic bleach tanning agent (TANIGAN®BL-I, LANXESS Deutschland), 2% of vegetable oil-based fatliquoring agent and 0.5% of neatsfoot oil. The leather is sammed, set out and hung to dry.

### EXAMPLE 1

Preparation of the hydrophobing agents to be used according to the invention In the absence of atmospheric humidity and water, the silanes mentioned were homogeneously mixed with one another and/or with previously dewatered additives.

| | Composition of the preparation: Data in % by weight | | | | | | | | | | | | | |
|---|---|---|---|---|---|---|---|---|---|---|---|---|---|---|
| | Ex. | Ex. | Ex. | Ex. | Ex. | Ex. | Ex. | Ex. | Ex. | Ex. | Ex. | Ex. | Ex. | Ex. |
| Ingredients | 1A | 1B | 1C | 1D | 1E | 1F | 1G | 1H | 1I | 1J | 1K | 1L | 1M | 1N |
| Octadecyltrimethoxysilane | 100 | 80 | | 75 | | 50 | 30 | 85 | | | 82 | 40 | 35 | 50 |
| Hexadecyltrimethoxysilane | | 20 | | | | | | | 50 | 67 | | 40 | 35 | 10 |
| Hexadecyltriethoxysilane | | | 100 | | 50 | | | | | | | | | |
| Octyltrimethoxysilane | | | | 25 | | | | | | | | | | |
| Ethyltriethoxysilane | | | | | 50 | | 40 | | | | | | | |
| Methyldimethoxysilane | | | | | | 50 | | | | | | | | |
| Methyltrimethoxysilane | | | | | | | 30 | | | | | | | |
| Polydimethylsiloxane | | | | | | | | 15 | 50 | | | | | |
| 1000 mPa · s | | | | | | | | | | | | | | |
| Polydimethylsiloxane | | | | | | | | | | 33 | | | | |
| 100 mPa · s | | | | | | | | | | | | | | |
| Polydimethylsiloxane- | | | | | | | | | | | 18 | | | |
| dicarboxylic | | | | | | | | | | | | | | |
| acid | | | | | | | | | | | | | | |
| 1500 mPa · s | | | | | | | | | | | | | | |
| Toluene | | | | | | | | | | | | 20 | | |
| Ethyl acetate | | | | | | | | | | | | | 30 | |
| Ethanol | | | | | | | | | | | | | | 40 |

### EXAMPLE 2

### Hydrophobing of Sole Leather

The sole leather (leather 1) having a thickness of 4.5-5 mm was treated with various preparations from example 1 as shown in the following table and, after complete penetration of the product (testing of section), was conditioned for 10 days at 65% relative humidity at 25° C.

The treated leathers obtained have a stiffness which is comparable or slightly better than that of the untreated reference. The natural colour is comparable or only slightly darker. On flexing the leather, the grain remains intact and no cracking occurs.

The testing of the water-repellent treatment was effected by the Kubelka water absorption test: DIN EN 12990 (lower values=>better water repellency, good penetration of the product) and the water drop test. For this purpose, a drop of water of 0.2 ml volume is applied to the leather surface (grain side) and the time taken for the drop to be completely drawn into the leather is measured. Longer times correspond to better water repellency.

| | Product | | | | | | | | | |
|---|---|---|---|---|---|---|---|---|---|---|
| | 1A | 1B | 1B | 1B | 1B | 1F | 1J | 1K | 1M | Ref |
| Application to grain side [%] | — | — | — | 5 | — | 7 | 12 | 6 | 15 | — |
| Application to flesh side [%] | 10 | 7 | 10 | 5 | 15 | 7 | — | 6 | — | — |
| Drop fastness [min] | 115 | 35 | 110 | 125 | 240 | 90 | 135 | 160 | 115 | 1 |
| Kubelka 2 h [%] | 19 | 24 | 20 | 20 | 15 | 21 | 18 | 16 | 19 | 27 |
| Kubelka 24 h [%] | 29 | 35 | 28 | 27 | 22 | 30 | 28 | 26 | 27 | 47 |

By storage in a saturated formic acid atmosphere (25° C.), the conditioning time could be reduced to 3 days with comparable hydrophobing values.

1. A Process for hydrophobing a leather tanned with organic tanning agents, wherein the leather is treated with a preparation containing at least one alkylalkoxysilane of the formula I
R¹R² Si(OR³)(OR⁴) (I),
in which
R¹ represents a C₁-C₃₀-hydrocarbon radical,
R³ and R⁴, independently of one another, represent a C₁-C₁₀-hydrocarbon radical, and
R², independently of R¹, has the meaning of R¹ or represents OR³ or OR⁴.

2. The Process according to claim 1, wherein the alkylalkoxysilane of the formula I is dialkyldimethoxysilane, alkyltrimethoxysilane, dialkyldiethoxysilane, alkykltriethoxysilane or mixtures thereof, the alkyl groups having 6 to 20 C atoms.

3. The Process according to claim 1, wherein the alkylalkoxysilane is hexadecyltrimethoxysilane, octadecyltrimethoxysilane, hexadecyltriethoxysilane, octadecyltriethoxysilane or mixtures thereof.

4. The Process according to claim 1, wherein the preparation contains at least 30% by weight, of alkylalkoxysilanes of the formula I.

5. The Process according to claim 1, wherein 2-30% by weight, based on the weight of the leather, of a preparation containing a silane of the formula I are used.

6. The Process according to claim 1, wherein preparations are applied to one or both sides of the leather at 0-60° C. by spraying on, knife coating, pouring, printing or immersion.

7. The Process according to claim 1, wherein the leather has a proportion of chromium of less than 2000 ppm.

8. The Process according to claim 1, wherein at least 20% by weight, based on the pelt weight, of organic, in particular of vegetable and/or synthetic, tanning agents are used.

9. A process for hydrophobing leather tanned with organic tanning agents, wherein alkylalkoxysilane of the formula I
R¹R² Si(OR³)(OR⁴) (I),
in which
R¹ represents a C₁-C₃₀-hydrocarbon radical,
R³ and R⁴, independently of one another, represent a C₁-C₁₀-hydrocarbon radical, and
R², independently of R¹, has the meaning of R¹ or represents OR³ or OR⁴, are used.

10. Leather tanned with organic tanning agents and obtainable according to a process according to claim 1.

11. Leather tanned with organic tanning agents, wherein it was treated with at least one alkylalkoxysilane of the formula I
R¹R² Si(OR³)(OR⁴) (I),
in which
R¹ represents a C₁-C₃₀-hydrocarbon radical,
R³ and R⁴, independently of one another, represent a C₁-C₁₀-hydrocarbon radical and
R², independently of R¹, has the meaning of R¹ or represents OR³ or OR⁴.

12. A process for applying the leather according to claim 9 or 10 as shoe leather, belts, straps, saddles or bags.
